(19) United States
(12) Patent Application Publication
(10) Pub. No.: US 2018/0118391 A1
(43) Pub. Date: May 3, 2018

(54) DEVICE FOR VACUUM PACKAGING OF FOODS

(71) Applicants: Simone ABATE, Desenzano del Garda (BS) (IT); Giancarlo PAROLINI, Desenzano del Garda (BS) (IT)

(72) Inventors: Simone ABATE, Desenzano del Garda (BS) (IT); Giancarlo PAROLINI, Desenzano del Garda (BS) (IT)

(21) Appl. No.: 15/571,884

(22) PCT Filed: May 5, 2016
(86) PCT No.: PCT/IB2016/052565

§ 371 Date: Nov. 6, 2017

(30) Foreign Application Priority Data
May 7, 2015 (IT) MI2015A000644

(51) Int. Cl. B65B 31/04; B65B 31/02; B65B 51/22; A23L 3/3418

(52) U.S. Cl. CPC B65B 31/048; B65B 31/024; A23V 2002/00; A23L 3/3418; B65B 51/22

(57) ABSTRACT

A device for vacuum packaging of foods is provided. The device has an enveloping unit defining a vacuum chamber adapted to accommodate part of the opening of a food packaging bag, and a suction unit adapted to suction air and make a vacuum, in the vacuum chamber. The enveloping unit and the suction unit are reciprocally movable independently from one another, with the enveloping unit being fluidically connected to the suction unit by means of a suction pipe.

### FIELD OF THE INVENTION

The present invention relates to vacuum packaging of foods, or other items, for domestic and professional use (for example bars, campers, boats, airplanes, etc.).

### KNOWN PREVIOUS ART

It is well known that food, if left exposed to air, is subjected to deterioration that causes both loss of flavor and loss of nutritional properties in food, up to make it even detrimental if ingested. This deterioration is caused by chemical, for example oxidation, and microbiological reactions, due to microorganisms finding in the food exposed to air an ideal substrate on which they proliferate. Most of organisms indeed need oxygen to be able to develop. By taking oxygen away from food, microorganism proliferation can be limited, or nearly eliminated, and food deterioration processes can be thereby delayed.

One of the most effective ways of food preservation and packaging, that allows insulating the food product from air and thus from oxygen, is the vacuum packaging method. For example, a food is placed inside a package, a bag, a jar or a box, from which air is then suctioned, thus making vacuum inside the package, for example inside the bag. Vacuum packaging and preservation of food originally developed in industrial environments, with time and increasing diffusion of compact size packaging devices, also spread to the domestic environment.

Vacuum packaging machines mainly fall into two categories: the “external suction” ones, and the so called “bell-like” types.

In the “external suction” machines the envelope inside which vacuum is made is external to the machine, whereas the “bell-like” machines generally have an inner chamber, inside which vacuum is made. In this case, for example, any envelope put inside this chamber is vacuumed by removing air from the entire chamber volume.

Of the two typologies the most popular for domestic use is the “external use” one.

In this type of machines, usually a compressor suctions air from an appropriate bag containing the item to be vacuum preserved, or from an appropriate pipe that can be connected to specific lids able to suction air from a rigid container.

More specifically, by considering for example the bag sealing machines, in particular for domestic use, devices are known in the background art having a box-shaped body generally comprising a compressor that suctions air from the bag, and a vacuum enveloping unit usually provided with sealer adapted to operate the real food packaging and the bag tight sealing, after all the air has been removed from the inside thereof.

These devices, although having compact sizes suitable for domestic use, have some problems.

A problem with such devices is the excessive weight. In fact, these devices reach a significant weight that renders the same unwieldy and difficult to displace from a point to another of the room or the table on which the work is done.

As mentioned, the normal use of these devices is made uncomfortable by their weight; in fact, since they have to be used, a first physical effort has to be done in order to extract them from their storage place and to position them in the desired place, and at least a second physical effort has to be done to store the same, at the end of their use, in the place intended for their preservation.

A further disadvantage of such devices is their bulk; this results in the reduction of the potentially usable room in the kitchen and, thus, inconveniences for who is cooking.

Finally, such devices have the further drawback of being extremely noisy and thus, during their operation, they can also be rather annoying for the operator.

These problems become worse as the device power increases and thus the size and weight increase, in particular of the compressor and the transformer.

Object of the present invention is to provide a device that overcomes the problems of known devices, i.e. that can be moved easily and with the minimum physical effort.

Further object of the present invention is to provide a device that allows obtaining a high vacuum level, that is displaceable with an effort smaller than that one required by known art devices, and reduces bulks.

Further object of the present invention is eventually to provide a device also less noisy than those of known art.

### SUMMARY OF THE INVENTION

These and other objects are achieved by the present invention, whose object is a device for vacuum packaging of foods, comprising an enveloping unit that defines a vacuum chamber adapted to accommodate at least part of the opening of a food packaging bag, and an air suction unit adapted to make an at least partial vacuum inside the vacuum chamber; such a device is characterized in that the enveloping unit and the suction unit are reciprocally movable independently one from another and are fluidically connected one to another by means of a suction pipe.

Advantageously, the device according to the present invention therefore comprises two separated units, the enveloping unit and the suction unit, both being able to be displaced independently from one another; in fact, the two units can be connected by means of a suction pipe preferably of flexible, and/or extensible, and/or bellows-like type that allows moving the two unit independently one from another, while remaining constrained to one another. When the two units are constrained, the device can be used in order to vacuum package foods or other items, for example.

According to an embodiment of the device according to the present invention, the suction pipe can be released from the enveloping unit and/or the suction unit, so as to facilitate the displacement of the various components individually, or leaving one of the two units constrained to the suction pipe.

In particular the suction unit that can comprise, for example, at least one compressor and/or at least one impeller in conjunction with at least one transformer and/or an electric controller card, is usually the component that mostly affects the device weight; according to the present invention, such a unit can be positioned in a predetermined kitchen point and, by being releasable from the enveloping unit, for example by disconnecting the suction pipe, the enveloping unit, the suction pipe and possible accessories can be moved and stored elsewhere with respect to the suction unit, without effort and with large handling easiness.

Advantageously the suction unit can be, for example, coupled to a wall unit that can provide, for example, an appropriate housing for such a suction unit, so as to render subsequent displacements thereof unnecessary and further to preserve the appearance and bulk issue of the entire device. This way no physical efforts will be required to the user any more in order to displace a heavy device, such as those of known art, but the enveloping unit and the suction pipe can be simply displaced and, when necessary, connected and disconnected. In addition, since the suction unit will not have to be moved, it could also have larger sizes and weight, and thus higher power, with respect to the known devices, in particular with respect to devices for domestic use.

Furthermore, also when the device is in use configuration, i.e. when the suction unit is fluidically connected to the enveloping unit by means of the suction pipe, the enveloping unit can be displaced with respect to the suction unit. In fact, according to a preferred embodiment of the present invention the suction pipe can be, for example, of flexible, and/or extensible, and/or bellows-like type, thus allowing the enveloping unit to be freely and without any effort displaced from the suction unit, even when they are connected one to another. This allows using the device by freely displacing the only light and handy enveloping unit from a point to another, for example of a working surface on which the device has been positioned, without having to also displace the heavier suction unit.

In a preferred embodiment, the device according to the present invention comprises at least one welding member adapted to weld at least part of the opening of a food packaging bag, after an at least partial vacuum has been made inside such a bag; welding members adapted to be used in the present invention are known in the art. For example, a preferred welding member according to an embodiment of the present invention comprises at least one heating member.

In a preferred embodiment of the device according to the present invention, the enveloping unit is electrically supplied by means of electric cables, and such electric cables are coupled to the suction pipe. Preferably, the electric cables run inside said suction pipe. In this particular embodiment, since the supply electric cables of the enveloping unit run inside the suction pipe connecting the suction unit to such an enveloping unit, the connection of the various units and the device implementation are significantly simplified. In fact, according to this preferred embodiment, the suction unit can be fluidically and concurrently electrically connected to the enveloping unit with a single piece, i.e. the suction pipe. According to a further embodiment, the electric cables are coupled to the suction pipe by means of a connection pipe. In this case, the electric cables can be positioned for example externally with respect to the suction pipe in which the suctioned air flows, still remaining coupled to such a suction pipe. In fact, in this particular embodiment both the electric cables and the suction pipe run inside the same connection pipe.

Another object of the present invention is a wall unit comprising at least one device according to the present invention, wherein the suction unit of such a device is constrained to the wall unit, whereas the enveloping unit and the suction pipe, being releasable from the suction unit, are releasable from the wall unit.

### BRIEF DESCRIPTION OF THE FIGURES

These and other aspects of the present invention will be made clearer by the following specification of preferred embodiments, herein provided for purposes of illustration only and without limitation, with reference to the accompanying figures, in which:

FIG. 1 and FIG. 2 show an embodiment of the device according to the invention: in FIG. 1 the enveloping unit is shown closed, whereas in FIG. 2 it is shown open.

FIGS. 3A, 3B and 3C show the different modalities in which, in an embodiment of the device according to the invention, the enveloping unit and the suction unit can be released one from another, for example by releasing one of the two units, or both, from the suction pipe.

FIGS. 4A and 4B show an embodiment of the device according to the invention in two different working positions.

FIGS. 5A and 5B schematically show two possible modalities for coupling a suction pipe according to the present invention, with electric cables.

FIGS. 6A, 6B and 6C depict an embodiment of a wall unit according to the present invention, to which a device according to the invention is constrained; in FIGS. 6A and 6B the device is shown in two different working positions, whereas in FIG. 6C the same device is shown in a not-in use position, wherein the suction unit remains constrained to the wall unit, whereas the enveloping unit and the suction pipe are disconnected from such a wall.

FIGS. 7A and 7B show an embodiment of the invention wherein the suction unit and the suction pipe are constrained to a wall of the working room, whereas the enveloping unit is firstly disconnected (FIG. 7A) from, then connected (FIG. 7B) to, the suction pipe.

FIGS. 7C and 7D show an additional embodiment of the invention wherein the suction unit and the suction pipe remain constrained to a wall of the working room, whereas the enveloping unit is stored in a movable housing.

### DETAILED DESCRIPTION

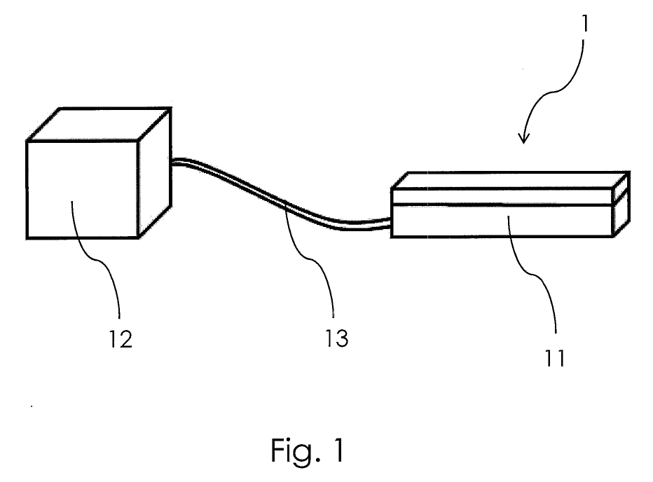

FIG. 1 shows a preferred embodiment of a device 1 according to the present invention.

In particular, an embodiment is schematically depicted showing an enveloping unit 11, a suction unit 12, and a suction pipe 13. The enveloping unit 11 is constrained to the suction unit 12 by means of the suction pipe 13. In this figure, as well as in the following ones, the shapes, sizes and proportions of the depicted elements have to be intended as merely illustrative and not limitative.

In practice, such a device 1 is a real household appliance that can be used in the kitchen in both private and professional environments. In the light of what mentioned, such a device can also be used inside campers, boats or airplanes. Furthermore it has to be mentioned that, despite hereinbelow the vacuum packaging of foods will be denoted as the preferred field of device use, however such a device could be validly used also in order to vacuum pack different products such as, for example, pillows, blankets, clothes or even other products.

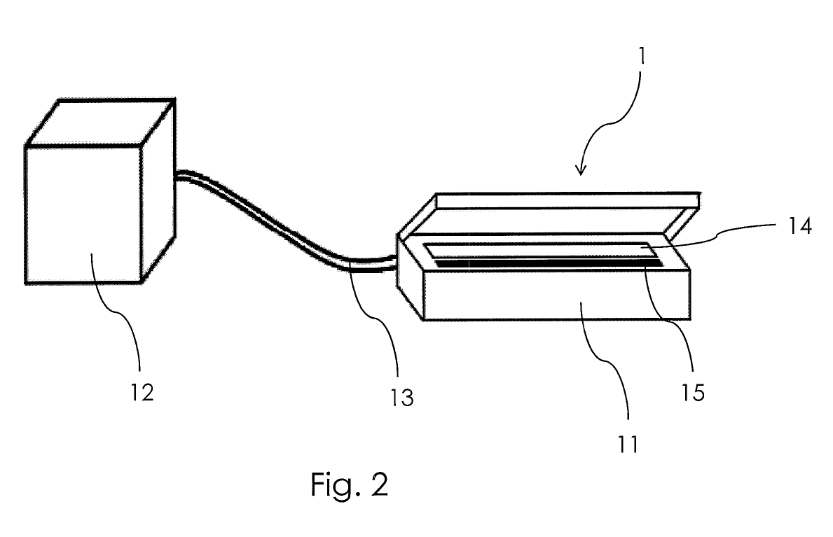

In FIG. 2 the same embodiment of FIG. 1, i.e. a device 1 having an enveloping unit 11 and a suction unit 12 connected one to another by means of a suction pipe 13, is depicted.

In FIG. 2 the enveloping unit 11 is shown in open configuration. In this representation, a vacuum chamber 14 and a welding member 15 are shown, in this case inside the enveloping unit 11. As discussed above, welding members suitable to be used in the present invention are known in the art. According to a preferred embodiment of the present invention, the welding member 15 preferably comprises at least one heating member.

Despite not shown herein, the suction unit 12 however comprises a compressor, a transformer and a controller card. In other embodiments the suction unit 12 can also comprise an aspirator in place of the compressor.

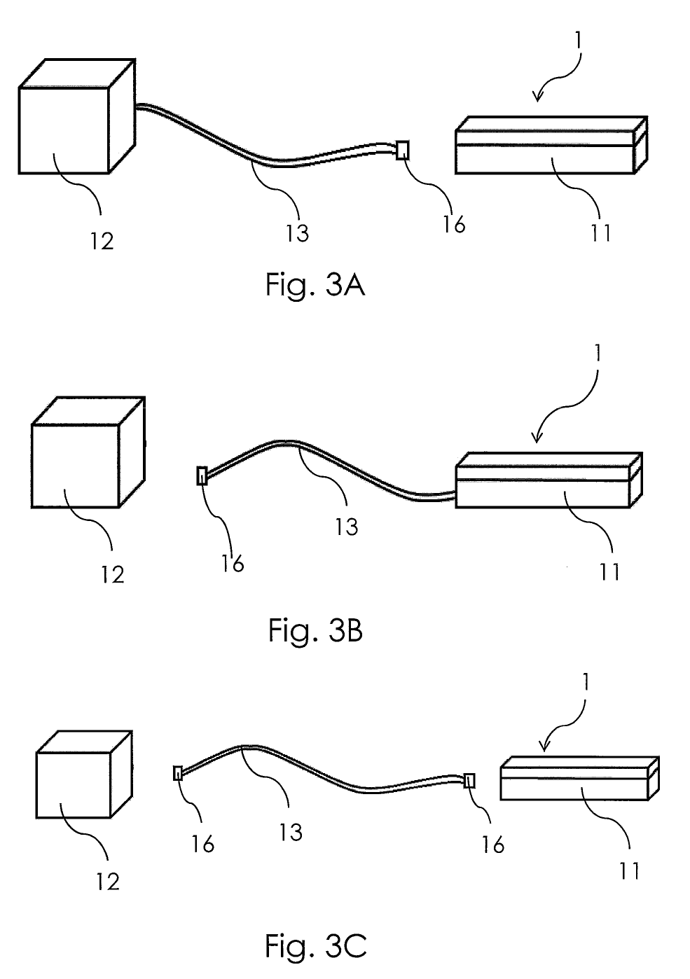

In FIGS. 3A, 3B and 3C, 3 different configurations are schematically depicted, wherein according to a preferred embodiment of the device 1 of the present invention when the device is not in use there can be the enveloping unit 11, the suction unit 12 and/or the suction pipe 13.

In the embodiment shown in FIGS. 3A, 3B and 3C, the present invention is particularly advantageous with respect to known devices since the possibility of releasing the different units of the device 1 one from another significantly facilitates the displacement of various components individually, or leaving one of the two units constrained to the suction pipe.

In fact, for example as shown in FIG. 3A, the enveloping unit 11 can be released individually from the other components of the device 1. In this case, the suction pipe 13 remains connected to the suction unit 12. In FIG. 3A also coupling means 16 are shown, through which the suction pipe 13 can be constrained to the enveloping unit 11.

FIG. 3B shows another possible configuration of the device 1 when not in use. In this case, the suction unit 12 is shown released from the suction pipe 13 remaining connected to the enveloping unit 11 instead. Furthermore, in FIG. 3B coupling means 16 for the connection of the suction pipe 13 to the enveloping unit 12 are shown.

FIG. 3C shows an additional possible configuration of the device 1 when not in use. In this case, the suction pipe 13 is released both from the suction unit 12 and the enveloping unit 11. At the two ends of the suction pipe 13, the coupling means 16 for connecting the suction pipe 13 to the suction unit 12 and to the enveloping unit 11 are shown.

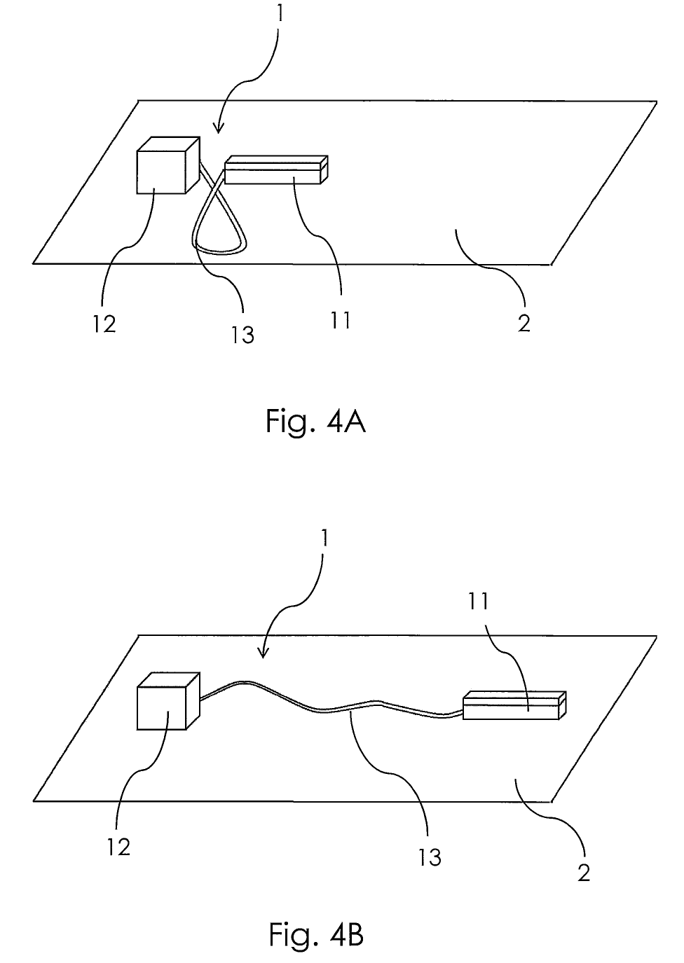

FIGS. 4A and 4B show an embodiment of the device 1 according to the invention in two different working positions.

In FIG. 4A the device 1, positioned on a working surface 2, is shown. The suction unit 12, the suction pipe 13 and the enveloping unit 11 are shown. Specifically, in FIGS. 4A and 4B a preferred embodiment of the device 1, in which the suction pipe 13 is of flexible type, is shown. In fact, in FIG. 4A the enveloping unit 11 is shown as positioned on the working surface 2 proximal to the suction unit 12. In this case the suction pipe 13, specifically of flexible type, is shown as bent on itself.

The same embodiment of the device 1 of FIG. 4A is shown in FIG. 4B: in this case the enveloping unit 11, constrained to the suction unit 12 by means of the suction pipe 13, is spaced from the suction unit 12, on the working surface 2.

As it can be noted in FIGS. 4A and 4B, the device 1 according to the present invention is particularly advantageous with respect to known devices, as when the suction unit 12 is fluidically connected to the enveloping unit 11 by means of the suction pipe 13, for example, the enveloping unit 11 can be displaced on the working surface 2 with respect to the suction unit 12. In FIGS. 4A and 4B an embodiment of the device 1 according to the invention is schematically shown, wherein such a device 1 can be used by displacing, according to operator needs, the enveloping unit 11 alone usually lighter and handier than the suction unit 12, from a point to another of a working surface 2 on which the device 1 has been positioned, without the suction unit 12 having to be mandatorily displaced.

It has to be noted that despite the embodiment shown in FIGS. 4A and 4B shows a device 1 wherein the suction pipe 13 is of flexible type, however an embodiment wherein such a suction pipe 13 is of extensible or bellows-like type still falls in the protection scope of the present invention.

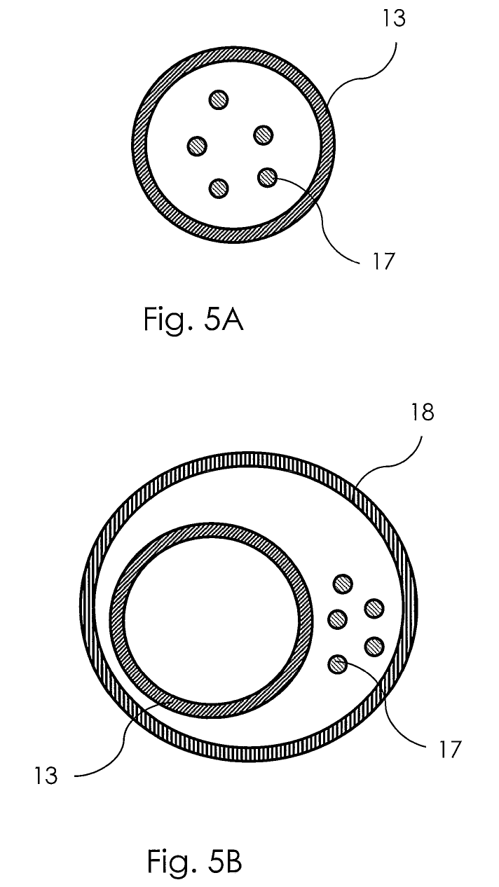

FIG. 5A shows an embodiment of the present invention; in particular, a section of the suction pipe 13 is shown. In this particular preferred embodiment, electric cables 17 adapted to supply the enveloping unit 11 run inside the suction pipe 13 through which air, from the bag positioned in the enveloping unit 11, is suctioned. In particular, such electric cables 17 are intended to supply, for example, the welding member 15 and/or, for example, a control unit for controlling and adjusting the operation and use parameters of the enveloping unit 11, in addition to possible devices needing electrical supply.

FIG. 5B shows another embodiment of the invention, wherein the electric cables 17 for supplying the enveloping unit 11 run outside of the suction pipe 13; in this particular embodiment, the suction pipe 13 is coupled to the electric cables 17 by means of a connection pipe 18. In this embodiment, the enveloping unit 11 is constrained to the suction unit 12 by means of a connection pipe 18 inside which the suction pipe 13 and the electric cables 17 run. In FIG. 5B, the connection pipe 18, the suction pipe 13 and the electric cables 17 are depicted in cross section.

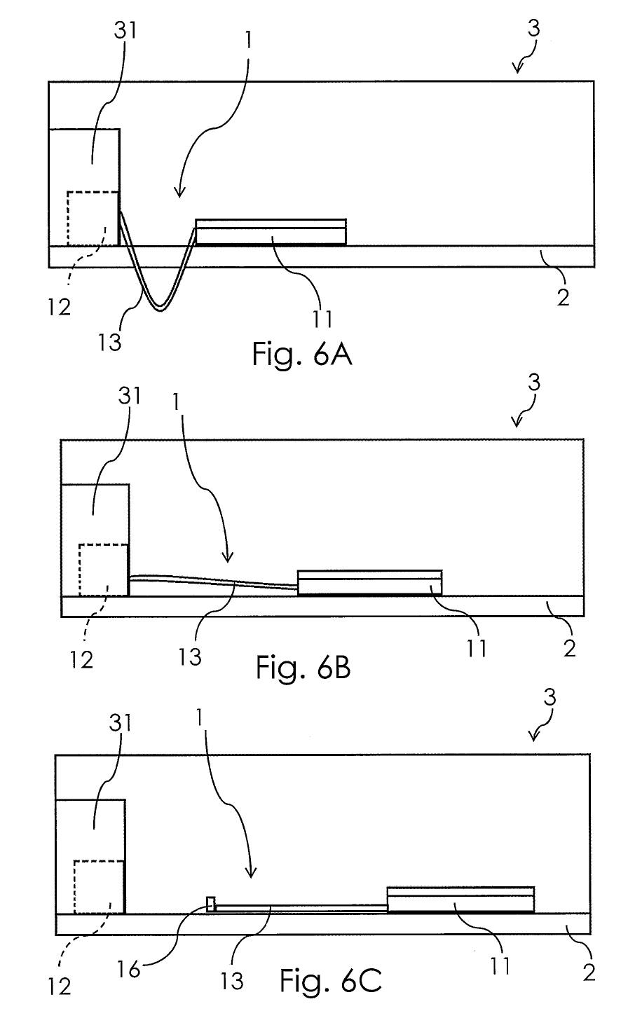

In FIG. 6A, an embodiment of a wall unit 3 according to the present invention is schematically depicted. In this case, the device 1 of the invention is constrained to the wall unit 3 by means of a housing 31. More specifically, in FIG. 6A an embodiment is shown wherein the suction unit 12 of the device 1 is positioned inside such a housing 31 of the wall unit 3 and is connected to the enveloping unit 11, the latter being positioned on the working surface 2 by means of a suction pipe 13.

Such a housing 31 of the wall unit 3 can be, for example, a niche in a piece of furniture purposely designed for accommodating the suction unit 12. According to other preferred embodiments of the invention, other examples of housing 31 of the wall unit 3 can be a shelf, a cabinet or a drawer. According to a further embodiment, a housing 31 for the suction unit 12 can be obtained inside a wall of the working room.

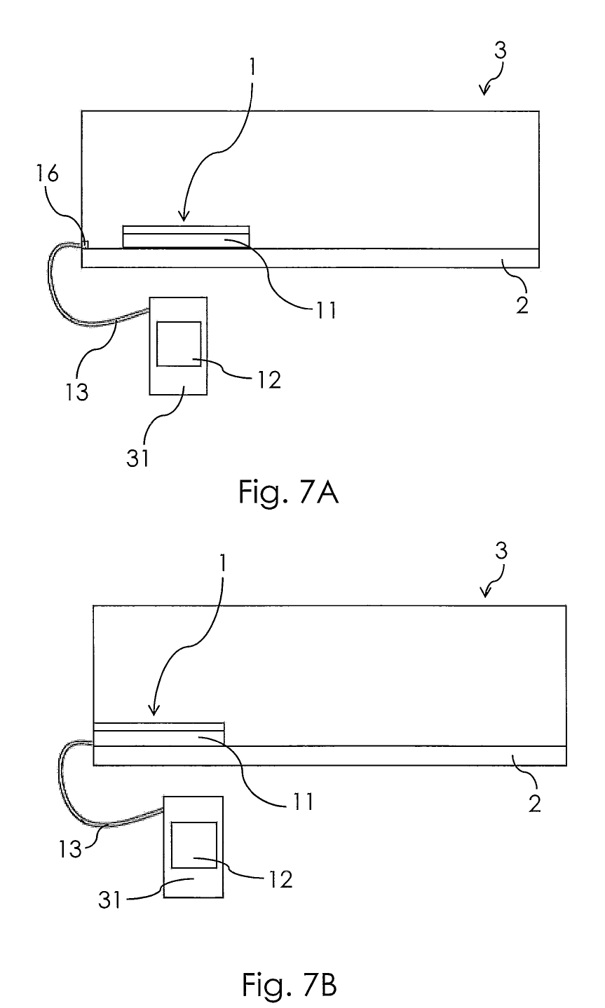

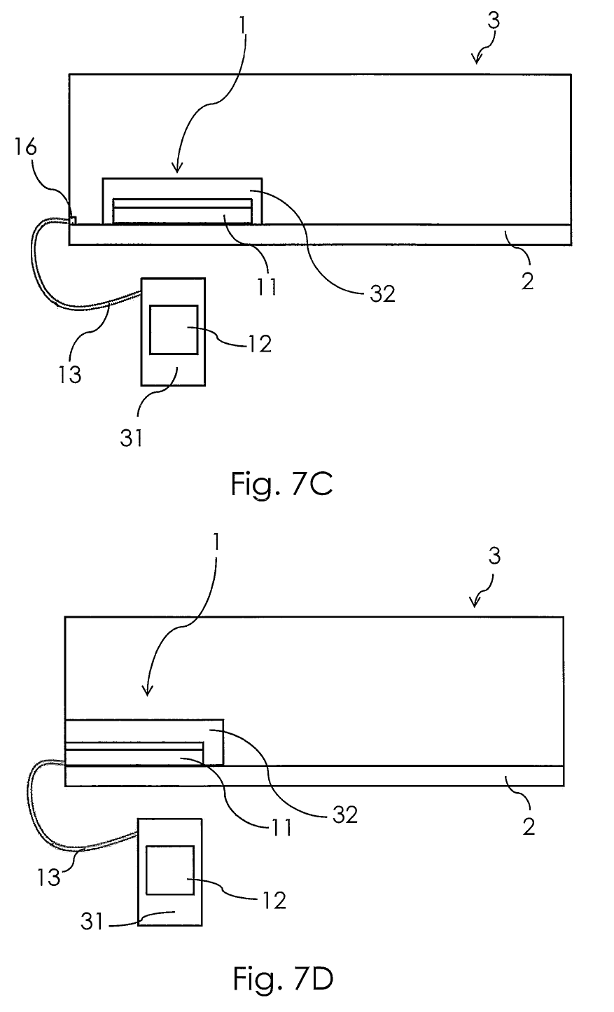

In such a case, the suction pipe 13 could come out of the wall in which the suction unit 12 is recessed, or as shown in FIGS. 7A and 7B, could be included too in the wall. In this last case also the coupling means 16 for connecting the suction pipe 13, which in FIGS. 7A and 7B is shown constrained to the suction unit 12, are fastened to the wall at the working surface 2 on which the enveloping unit 11 is rested. In accordance with such an embodiment, in case of need, the enveloping unit 11 is displaced from a first position, wherein it is for example usually stored (FIG. 7A), to a second position (FIG. 7B), wherein it is combined with the suction pipe 13 to be then used. Such a solution allows therefore positioning the suction unit 12 in any position, or wall, of the working room and then, prearranging the suction pipe 13 in another position, for example through a suitable chase obtained in the wall, up to reach the working surface 2.

In the above described cases, in which the suction unit 12 is constrained to the wall unit 3 by means of a housing 31 in the wall unit 3, for example, such as the recess niche of a piece of furniture purposely designed for accommodating the suction unit 12 or a cabinet, or a drawer, or else obtained inside a wall of the working room, the noisiness of the suction unit 12 itself is reduced to extremely low levels.

According to a further embodiment of the invention, shown in FIGS. 7C and 7D, the wall unit 3 comprises a further housing 32 for the enveloping unit 11. Such a second housing 32, which for example can include a drawer, is movable to allow combining the enveloping unit 11 with the suction pipe 13, when needed. In particular, FIG. 7C shows the second housing 32 and the enveloping unit 11 in a first not-in use position, whereas FIG. 7D shows the second housing 32 and the enveloping unit 11 in a second use position. In such an embodiment both the suction unit 12 and the suction pipe 13 are fixed, as shown in FIGS. 7A and 7B and described above.

In FIG. 6B the same embodiment of FIG. 6A is shown, wherein the device 1 according to the invention is constrained to the wall unit 3 by means of a housing 31. In FIG. 6B, how the enveloping unit 11 can be moved independently, for example moved away from the suction unit 12 on the working surface 2 while remaining constrained to the same by means of the suction pipe 13, is shown. This embodiment is particularly advantageous, since the enveloping unit 11 can be displaced effortlessly from a point to another of the working surface 2, without the need of displacing the suction unit 12 remaining constrained to the wall unit 3, for example inside an appropriate housing 31. A particular advantage of this embodiment is that, since the suction unit 12 is positioned inside a housing 31, there will be more available room on the working surface 2, thus taking advantage of more working room and reducing the disorder on the working surface.

In FIG. 6C the device 1 is shown, in a not-in use moment. In this case the enveloping unit 11, remaining constrained to the suction pipe 13, is disconnected from the suction unit 12 remaining inside the housing 31 of the wall unit 3. In this case, for the sake of simplicity, the enveloping unit 11 and the suction pipe 13 are represented on the working surface 2. Of course, when the work with the device 1 is ended, after the enveloping unit 11 and, possibly, also the suction pipe 13 have been disconnected from the suction unit 12, the enveloping unit 11 and the suction pipe 13 can be displaced everywhere by storing them in the place intended for their preservation. Advantageously, the suction unit 12 will not need to be displaced, thus remaining constrained to the wall unit 3 inside the housing 31. For the sake of clarity, in FIG. 6C coupling means 16 are depicted for connecting the suction pipe 13 in FIG. 6C constrained to the enveloping unit 11, to the suction unit 12.

1. A device for vacuum packaging of foods, comprising an enveloping unit defining a vacuum chamber adapted to accommodate part of the opening of a food packaging bag, and a suction unit adapted to suction air and make a vacuum, in said vacuum chamber, wherein said enveloping unit and said suction unit are reciprocally movable independently from one another, said enveloping unit being fluidically connected to said suction unit by means of a suction pipe.

2. The device according to claim 1, wherein said enveloping unit comprises a welding member adapted to weld part of the opening of a food packaging bag after a vacuum has been made inside said bag.

3. The device according to claim 2, wherein said welding member comprises a heating member.

4. The device according to claim 1, wherein said enveloping unit is electrically supplied by means of electric cables, and said electric cables are coupled to said suction pipe.

5. The device according to claim 4, wherein said electric cables run inside said suction pipe.

6. The device according to claim 4, wherein said electric cables are coupled to said suction pipe by means of a connection pipe.

7. The device according to claim 1, wherein said suction pipe is of the flexible, and/or extensible, and/or bellows-like type.

8. The device according to claim 1, wherein said suction pipe is releasable from said enveloping unit and/or said suction unit.

9. The device according to claim 1, wherein said suction unit comprises a compressor and/or an impeller and/or a transformer and/or a controller card.

10. A wall unit comprising a device according to claim 1, wherein said suction unit is constrained to said wall unit.

11. The wall unit according to claim 10, wherein said enveloping unit is releasable from said wall unit.

12. The wall unit according to claim 10, further comprising a housing to house said one suction unit and/or said suction pipe.

13. The wall unit according to claim 10, further comprising a second housing to house said enveloping unit.

14. The wall unit according to claim 13, wherein said second housing is movable.
